(19) United States
(12) Patent Application Publication
(10) Pub. No.: US 2012/0175540 A1
(43) Pub. Date: Jul. 12, 2012

(54) HYDRAULIC PRESSURE CONTROLLING SOLENOID VALVE

(76) Inventor: Hirofumi Hase, Tokyo (JP)

(21) Appl. No.: 13/375,988

(22) PCT Filed: Sep. 28, 2009
(86) PCT No.: PCT/JP2009/004917

§ 371 Date: Dec. 2, 2011

(51) Int. Cl. F01M 1/16; F16K 31/04

(52) U.S. Cl. 251/129.15

(57) ABSTRACT

A part of drain oil discharged from a retard hydraulic chamber 34 and led out of a port 21 to a port 20 is introduced through oil introduction grooves 18, which are provided in the outer periphery of a land portion 17a of a spool valve 17, into a slide bearing portion 14d between a cup member 14 and a plunger 15 and caused to serve as lubricating oil. In addition, foreign substances in the cup member 14 are discharged from a cup hole 14b to a cup outside space B as the plunger 15 reciprocatingly slides.

### TECHNICAL FIELD

The present invention relates to a hydraulic pressure controlling solenoid valve for controlling a hydraulic pressure supplied to a hydraulic actuator in an internal combustion engine.

### BACKGROUND ART

Heretofore, for a hydraulic pressure controlling solenoid valve which opens/closes an oil passage to a hydraulic actuator in an internal combustion engine to control a hydraulic pressure, variety of bearing structures each using the moving part of a solenoid portion have been devised. For example, a solenoid valve proposed in Patent Document 1 is configured such that a non-magnetic thin cup member is disposed between the outer periphery of a moving part coupled to a spool valve and the inner periphery of a stator, to thus function as a bearing by sliding the moving part to the cup member.

### PRIOR ART DOCUMENTS

### Patent Documents

Patent Document 1: Japanese Patent Application Laid-open No. 2001-187979

### SUMMARY OF THE INVENTION

Since the conventional hydraulic pressure controlling solenoid valve is configured as described above, only the oil leaked out of the metal seal of the spool valve in which the oil passage is closed is introduced into a slide bearing portion between the moving part and the cup member. Therefore, the frictional resistance of the moving part increases to cause the abrasion and seizure of the slide bearing portion and reduce slidability, which poses a problem. The reduction of the slidability is also caused by the accumulation of foreign substances such as abrasion powder or the like on the bottom portion of the cup member serving as a stopper for restricting the slide of the moving part.

The present invention has been achieved in order to solve the problem as described above, and an object of the invention is to provide a hydraulic pressure controlling solenoid valve which is excellent in the abrasion resistance of a slide bearing portion between a moving part and a cup member, and has a performance to discharge foreign substances in a bearing structure using the cup member.

A hydraulic pressure controlling solenoid valve of the present invention includes: a moving part which reciprocatingly slides in an axial direction thereof by receiving an electromagnetic attractive force; a non-magnetic cup member serving as a bearing which houses the moving part in a reciprocatingly slidable manner in the axial direction, and having a bottom portion on one side in the axial direction and being open on the other side thereof; a stator which houses the cup member in the axial direction and is externally equipped with a coil to generate the electromagnetic attractive force; a housing which has a port for supplying oil to the hydraulic actuator and a port for discharging drain oil from the hydraulic actuator; a spool valve which is housed inside the housing in a reciprocatingly slidable manner in the axial direction and reciprocatingly slides integrally with the moving part to open and close each of the ports; and an oil introduction path which introduces the drain oil inside the housing into a slide bearing portion between the cup member and the moving part.

According to the present invention, when the drain oil inside the housing is introduced into the slide bearing portion between the cup member and the moving part, it is acted as lubricating oil in the slide bearing portion to thereby provide the hydraulic pressure controlling solenoid valve having an excellent abrasion resistance.

### BRIEF DESCRIPTION OF THE DRAWINGS

FIG. 1 is a cross-sectional view showing a configuration of a hydraulic pressure controlling solenoid valve of Embodiment 1 of the present invention, and shows a state thereof during a power-off period.

FIG. 2 is a cross-sectional view showing a state of the hydraulic pressure controlling solenoid valve shown in FIG. 1 during a power-on period.

FIG. 3 is a cross-sectional view showing a cup member of the hydraulic pressure controlling solenoid valve shown in FIG. 1 and its peripheral structure.

FIG. 4 is a cross-sectional view of the hydraulic pressure controlling solenoid valve shown in FIG. 1 taken along the line XX.

FIG. 5 is a cross-sectional view of a hydraulic pressure controlling solenoid valve of Embodiment 2 of the present invention taken at a position corresponding to the line XX shown in FIG. 1.

### BEST MODE FOR CARRYING OUT THE INVENTION

In the following, embodiments of the present invention will be described with reference to the accompanying drawings in order to explain the present invention in more detail.

### Embodiment 1

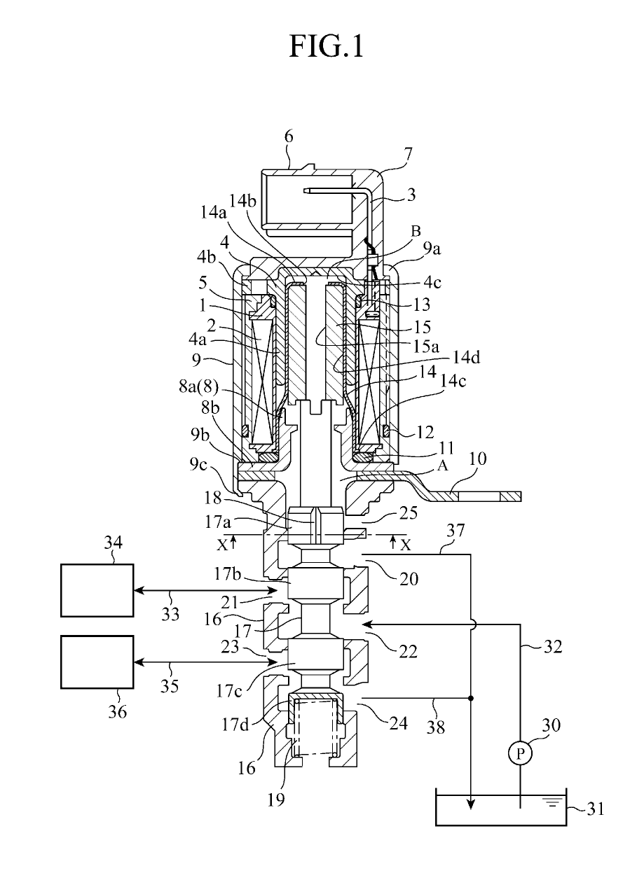

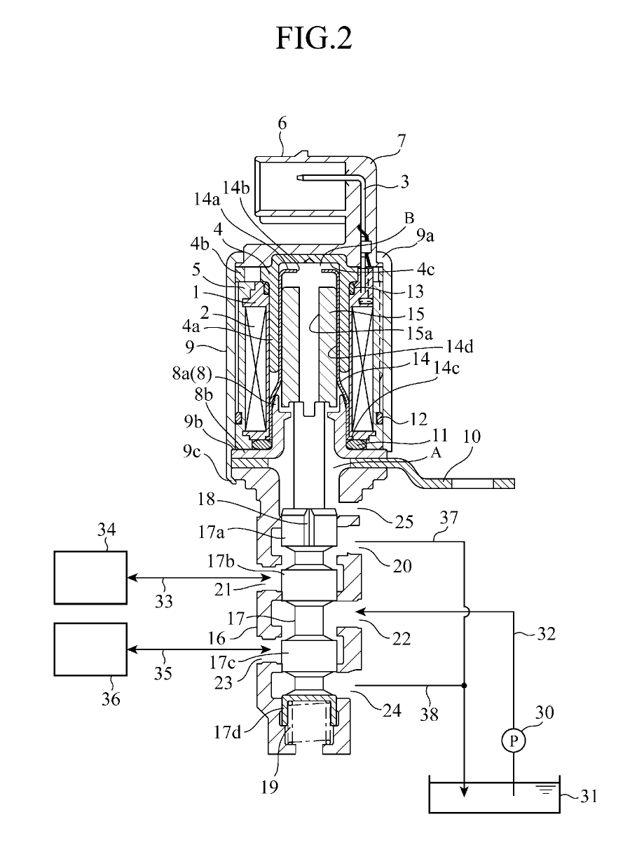

FIG. 1 is a cross-sectional view showing a configuration of a hydraulic pressure controlling solenoid valve of Embodiment 1 of the present invention during a power-off period, and FIG. 2 shows the state thereof during a power-on period. Hereupon, for descriptive convenience, it is assumed that a direction toward a position where a connector portion 6 of the hydraulic pressure controlling solenoid valve is disposed is an upward direction, while a direction toward a position where a spring 19 is disposed is a downward direction.

As shown in FIGS. 1 and 2, a hydraulic actuator having a retard hydraulic chamber 34 and an advance hydraulic chamber 36 is activated by receiving a hydraulic pressure supplied from a pump 30. At this point, the hydraulic pressure controlling solenoid valve of Embodiment 1 is used to control a flow rate of oil supplied from the pump 30 to the hydraulic actuator.

In the hydraulic pressure controlling solenoid valve, a bobbin 1 is formed in a tubular shape by resin molding and a coil 2 is wound around the outer periphery thereof. The leading end and terminal end of the coil 2 are each connected to a terminal 3 corresponding thereto, and a current is applied from the terminal 3 to the coil 2. A core 4 and a boss 8 each as a stator are inserted into the through hole of the bobbin 1. In the core 4, a core tubular portion 4a is inserted into the bobbin 1 from above, a core flange portion 4b covers the upper end portion of the bobbin 1, and a core bottom portion 4c closes the through hole of the bobbin 1. In the boss 8, a magnetic attractive portion 8a is inserted into the bobbin 1 from below.

A coil molded structure 7 is formed by integrally resin-molding the bobbin 1, the coil 2, the terminal 3, and the core 4 as inserted parts with a sheathing resin portion 5. In addition, the sheathing resin portion 5 is also integrally formed with the connector portion 6. A tubular case 9 constituting a magnetic circuit is circumferentially provided around the outer periphery of the coil molded structure 7. The upper end portion of the case 9 serves as a case bent portion 9a having an inwardly bent shape. The core flange portion 4b is fit in the inner peripheral portion thereof to thereby form a magnetic path, and also forms the co-axis of the core 4 and the case 9. The lower end portion of the case 9 is thinned to be formed with a case stepped portion 9b, and a boss flange portion 8b is fit in the stepped portion. Subsequently to the boss flange portion 8b, a bracket 10 for fixing the hydraulic pressure controlling solenoid valve and a housing 16 (described later) are inserted into the case stepped portion 9b, and then the lower end thereof is swaged to establish a case swaged portion 9c, which provide an arrangement such that the individual parts are integrally and coaxially held. Note that O-rings 11, 12, and 13 for securing airtightness are disposed at the lower end portion, around the outer peripheral surface, and inside the coil molded structure 7, respectively.

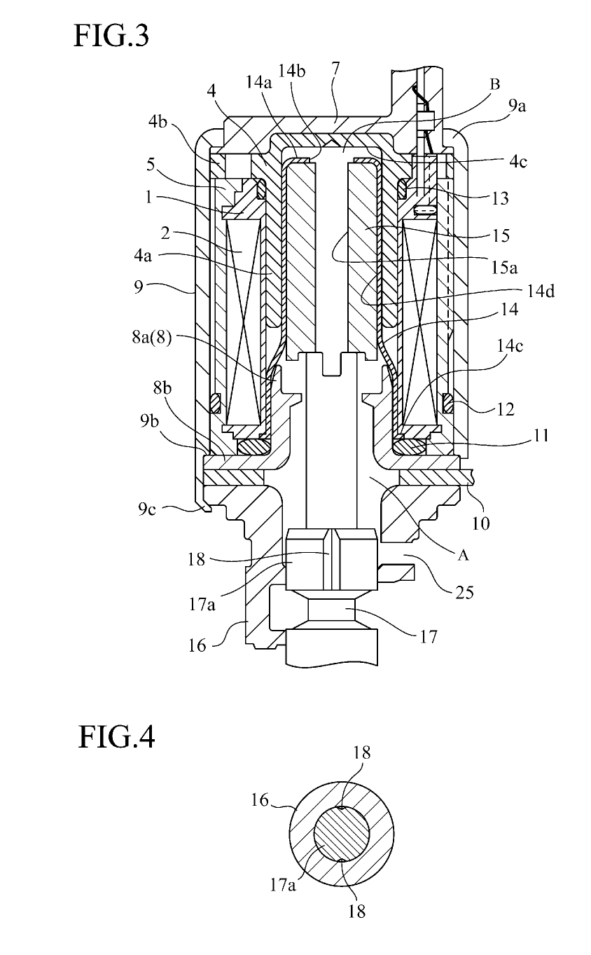

FIG. 3 shows a cross-sectional view in which the cup member of the hydraulic pressure controlling solenoid valve and a peripheral structure thereof are enlarged. A cup member 14 is formed of a non-magnetic thin plate and inserted into the bottomed tubular core 4 to function as a bearing. In the interior of the cup member 14, a plunger 15 as a moving part is housed to be reciprocatingly slidable in a vertical axial direction with a predetermined clearance. Hereinafter, a portion in which the inner peripheral surface of the cup member 14 and the outer peripheral surface of the plunger 15 slide is referred to as a slide bearing portion 14d. A cup bottom portion 14a is formed on the upper side of the cup member 14, and a cup hole (through hole of the cup member) 14b is drilled at the center of the cup bottom portion 14a. The cup bottom portion 14a comes in contact with the upper end surface of the plunger 15 to function as a stopper for regulating the movement of the plunger 15 during a power-off period. The lower end portion of the cup member 14 increases in diameter to house the magnetic attractive portion 8a of the boss 8 therein, and reaches the lower end surface of the bobbin 1; a cup flange portion (positioning member) 14c is formed at the peripheral edge of the opening of the cup member 14. By the engagement of the cup flange portion 14c with the lower end surface of the bobbin 1, the position of the cup member 14 in the vertical axial direction is determined. In such a way, the cup bottom portion 14a is away from the core bottom portion 4c to form a cup outside space B. Note that since a positioning portion can be formed in a region different from that of the slide bearing portion 14d, there is no deformation of the slide bearing portion 14d due to a load involved in a positioning, and therefore the degradation of a bearing function can be prevented. In addition, instead of the cup flange portion 14c, the positioning portion may also be a bent portion obtained by outwardly bending the peripheral edge of the opening or an engagement protruding portion provided to protrude outwardly.

A spool valve 17 is coupled to the lower end side of the plunger 15. A spring 19 is disposed at the lower end portion of the spool valve 17, and thus the plunger 15 and the spool valve 17 are constantly biased in the upward direction. During the power-off period shown in FIG. 1, the plunger 15 moves upward under the biasing force of the spring 19. On the other hand, during the power-on period shown in FIG. 2, the plunger 15 receives the electromagnetic attractive force of the magnetic attractive portion 8a of the boss 8 and moves downward against the biasing force of the spring 19. The movement range of the plunger 15 extends upward to the position where the upper end portion of the plunger 15 comes in contact with the cup bottom portion 14a, and downward to the position where the lower end portion of the spool valve 17 comes in contact with the bottom portion of the housing 16. In the center of the plunger 15, a plunger hole 15a is formed which extends therethrough in the vertical axial direction to function as an aspiration hole; when the plunger 15 operates, the plunger hole 15a absorbs volume changes in the upper and lower spaces of the plunger 15 to allow the plunger 15 to normally operate. In addition, in the case where the cup member 14 is formed with a thin plate to be functioned as an elastic member, and also the cup bottom portion 14a is apart from the core bottom portion 4c, even when the upper end portion of the plunger 15 abuts against the cup bottom portion 14a, the impact of the abutment is not transmitted to the core 4; thus, it is possible to reliably prevent abnormal noise at the time of the abutment.

The foregoing is the solenoid portion of the hydraulic pressure controlling solenoid valve.

Next, a flow rate regulating portion will be described.

The flow rate regulating portion includes the generally tubular housing 16 having a plurality of ports 20 to 24, the spool valve 17 housed in the interior of the housing 16 to be slidable in the vertical axial direction, and the spring 19 which constantly biases the spool valve 17 in the upward direction. As described above, since the upper end portion of the spool valve 17 is coupled to the plunger 15, the spool valve 17 moves in accordance with the amount of movement of the plunger 15. As a result, a plurality of land portions 17a to 17d formed in the spool valve 17 control the opening directions and amounts of the ports 20 to 24, respectively, to thus control the hydraulic pressure.

The port 22 communicates with an oil passage 32 which is the passage of the hydraulic pressure supplied by the pump 30 from an oil tank 31, and introduces oil into the housing 16. The port 21 communicates with an oil passage 33 to supply the oil to the retard hydraulic chamber 34 and also discharge the oil from the retard hydraulic chamber 34. The port 23 communicates with an oil passage 35 to supply the oil to the advance hydraulic chamber 36 and also discharge the oil from the advance hydraulic chamber 36. The port 20 communicates with an oil passage 37 to lead out the oil discharged from the retard hydraulic chamber 34 into the oil tank 31. The port 24 communicates with an oil passage 38 to lead out the oil discharged from the advance hydraulic chamber 36 into the oil tank 31.

FIG. 4 shows a cross-sectional view of the hydraulic pressure controlling solenoid valve taken along the line XX shown in FIG. 1. Of the land portions 17a to 17d, the land portion 17a formed at an uppermost position has oil introduction grooves (oil introduction path) 18 formed at two symmetric positions relative to the center of the cross section of the land portion 17a and extending therethrough in the vertical axial direction. When a current is applied to the hydraulic pressure controlling solenoid valve and the spool valve 17 moves downward as shown in FIG. 2, the oil flows from the port 22 to the port 23 (oil supply to the hydraulic actuator), and the drain oil flows from the port 21 to the port 20 (oil discharge from the hydraulic actuator). The latter drain oil flown from the port 21 to the port 20 is led out of the port 20 directly into the oil tank 31 through the oil passage 37, but the drain oil is also introduced as tributaries into the oil introduction grooves 18 of the spool valve 17. The drain oil passes through a solenoid inside space A formed around the spool valve 17 and is introduced into the slide bearing portion 14d between the plunger 15 and the cup member 14 to function as lubricating oil. Thus, it is possible to reduce the friction of the slide bearing portion 14d and prevent the abrasion and seizure of the plunger 15.

Note that since the oil introduced into the slide bearing portion 14d is the drain oil discharged from the retard hydraulic chamber 34, no pressure is produced in the solenoid portion so that the slidability of the plunger 15 is not affected.

However, slight abrasion of the plunger 15 due to the slide is inevitable, and powder of the abrasion is produced. Moreover, since the drain oil introduced into the slide bearing portion 14d is an lubricating oil for the inside of the internal combustion engine, fine abrasion powder and the like are originally mixed therein. Furthermore, since the slide bearing portion 14d is located inside the wound coil 2, the slide bearing portion 14d tends to reach a high temperature due to the heat generated from the coil 2 during the power-on period. Accordingly, the introduced drain oil also tends to reach a high temperature and, in that case, the degradation of the drain oil is promoted to probably cause a sludge-like deposit. Foreign substances such as the abrasion powder and the solidified/degraded oil are discharged from the slide bearing portion 14d by the sliding of the plunger 15 in the vertical axial direction to be released into the upper and lower spaces of the plunger 15 and gradually accumulated. In the hydraulic pressure controlling solenoid valve of Embodiment 1, the foreign substances released downward of the plunger 15 pass through the solenoid inside space A to be discharged from an externally open port 25 formed in the housing 16 to the outside, so that they pose no problem. In addition, the foreign substances released upward of the plunger 15 temporarily adhere to the cup bottom portion 14a, but are discharged from the cup hole 14b into the cup outside space B, so that they do not continue to stay in the interior of the cup member 14. Note that the foreign substances accumulated in the cup outside space B pass through the plunger hole 15a penetrating the upper and lower ends of the plunger 15 to be discharged into the solenoid inside space A. In this manner, it is possible to prevent a malfunction of the plunger 15 resulting from the accumulation of the abrasion powder and the degraded oil and secure the reliability of the slide bearing portion 14d.

As described above, according to Embodiment 1, the hydraulic pressure controlling solenoid valve is configured to include: the plunger 15 as the moving part which receives the electromagnetic attractive force and reciprocatingly slides in the axial direction, the non-magnetic cup member 14 serving as the bearing which houses the plunger 15 in a reciprocatingly slidable manner in the axial direction, and having the cup bottom portion 14a on one side in the axial direction, and being open on the other side thereof; the core 4 and the boss 8 which houses the cup member 14 in the axial direction and is externally equipped with the coil 2 to generate the electromagnetic attractive force; the housing 16 which has the ports 20 to 24 for supplying the oil to the hydraulic actuator and discharging the drain oil therefrom; the spool valve 17 which is housed in the housing 16 in a reciprocatingly slidable manner in the axial direction and reciprocatingly slides integrally with the plunger 15 to open and close each of the ports 20 to 24; and the axial oil introduction groove 18 provided in the outer periphery of the land portion 17a of the spool valve 17 as the oil introduction path which introduces the drain oil in the housing 16 into the slide bearing portion 14d between the cup member 14 and the plunger 15. As a result, when the drain oil introduced into the slide bearing portion 14d is functioned as a lubricating oil, it is possible to prevent the abrasion and seizure of the plunger 15 and the cup member 14 due to friction, which can provide the hydraulic pressure controlling solenoid valve having excellent abrasion resistance. In addition, when the drain oil is used as the oil to be introduced into the slide bearing portion 14d, no pressure is produced in the solenoid portion, so that the slidability of the plunger 15 is not affected. Further, the oil introduction groove 18 can be added through a simple machining.

In addition, according to Embodiment 1, the cup member 14 is configured such that the cup hole 14b is provided in the cup bottom portion 14a. As a result, even when the oil introduced into the slide bearing portion 14d remains in the cup member 14 and is solidified with foreign substances such as abrasion powder or degraded by a temperature rise due to the heat generated from the coil 2, the solidified/degraded oil can be discharged from the cup bottom portion 14a into the cup outside space B by the sliding of the plunger 15; consequently, it is possible to prevent a malfunction of the plunger 15. Moreover, when the cup hole 14b is prepared, the cup bottom portion 14a functions as an elastic member, so that it is possible to prevent abnormal noise at the time of the abutment of the plunger 15.

Further, according to Embodiment 1, the cup member 14 is configured such that the cup flange portion 14c is provided around the peripheral edge of the opening thereof, as the positioning portion for spacing the cup bottom portion 14a of the cup member 14 apart from the core bottom portion 4c of the core 4 to form the cup outside space B. Consequently, it is possible to discharge the foreign substances inside the cup member 14 into the cup outside space B through the cup hole 14b and prevent the deterioration of the slidability of the plunger 15. Note that the foreign substances and the like discharged into the cup outside space B and deposited in excess can be discharged from the externally open port 25 to the outside through the plunger hole 15a of the plunger 15 and via the solenoid inside space A. In addition, since the impact when the plunger 15 comes in contact with the cup bottom portion 14a is not transmitted to the core 4, abnormal noise can reliability be prevented. Further, since the positioning portion can be formed in a region different from that of the slide bearing portion 14d, that is, around the peripheral edge of the opening of the cup member 14, there is no deformation of the slide bearing portion 14d under a load involved in a positioning. Therefore, it is possible to prevent the degradation of the bearing function.

### Embodiment 2

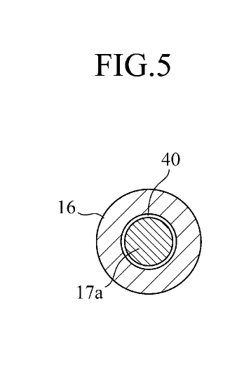

FIG. 5 is a cross-sectional view of a hydraulic pressure controlling solenoid valve of Embodiment 2 of the present invention taken at a position corresponding to the line XX shown in FIG. 1. The hydraulic pressure controlling solenoid valve of Embodiment 2 has the same configuration as that of Embodiment 1 described above except that instead of the oil introduction grooves 18 shown in FIG. 4, a clearance 40 shown in FIG. 5 is provided. Therefore, a description is given by extensively using FIGS. 1 to 3.

As shown in FIG. 5, the outer diameter of the land portion 17a is set smaller than the inner diameter of the housing 16 to form the clearance 40 serving as the oil introduction path around the entire circumference of the land portion 17a. Apart of a drain oil flowing from the port 21 to the port 20 is introduced from the clearance 40 into the slide bearing portion 14d between the plunger 15 and the cup member 14 via the solenoid inside space A. In a conventional solenoid valve, the outer periphery of the land portion 17a is caused to function as a metal seal; thus, the oil leaked out of the metal seal is insufficient in amount to be used as the lubricating oil for the slide bearing portion 14d. By contrast, since the land portion 17a of Embodiment 2 is provided with the clearance 40 having a predetermined width, the drain oil leaked out of the clearance 40 is allowed to function as the lubricating oil for the slide bearing portion 14d. Consequently, as in the foregoing Embodiment 1, it is possible to reduce the friction of the slide bearing portion 14d and prevent the abrasion or seizure of the plunger 15.

Thus, according to Embodiment 2, the hydraulic pressure controlling solenoid valve is configured such that as the oil introduction path, the clearance 40 is formed between the outer periphery of the land portion 17a of the spool valve 17 and the inner periphery of the housing 16. Therefore, when the outer diameter size of the land portion 17a and the inner diameter size of the housing 16 are adjusted, it is possible to easily provide the oil introduction path. In addition, when the clearance 40 is provided, it is possible to allow the drain oil to function as the lubricating oil for the slide bearing portion 14d and provide the hydraulic pressure controlling solenoid valve having excellent abrasion resistance.

Note that in each of the hydraulic pressure controlling solenoid valves of Embodiments 1 and 2 discussed above, the spool valve 17 is provided with the four land portions 17a to 17d, but it is not limited thereto. It is sufficient to provide the spool valve 17 with at least one land portion 17a to form the oil introduction grooves 18 or the clearance 40.

In addition, in each of the foregoing Embodiments 1 and 2, the port 21 of the hydraulic pressure controlling solenoid valve is allowed to communicate with the retard hydraulic chamber 34 and the port 23 thereof is allowed to communicate with the advance hydraulic chamber 36. Conversely, it may also be possible to allow the port 21 and the port 23 to communicate with the advance hydraulic chamber 36 and the retard hydraulic chamber 34, respectively, and introduce the drain oil in the advance hydraulic chamber 36 into the slide bearing portion 14d.

### INDUSTRIAL APPLICABILITY

As described above, in the hydraulic pressure controlling solenoid valve of the present invention, the drain oil discharged from the hydraulic actuator is used as the lubricating oil for the slide bearing portion; thus, the hydraulic pressure controlling solenoid valve is suitably used for a hydraulic pressure controlling solenoid valve using a non-magnetic cup member for a slide bearing portion.

1. A hydraulic pressure controlling solenoid valve for controlling a hydraulic pressure of a hydraulic actuator in an internal combustion engine, comprising:
a moving part which reciprocatingly slides in an axial direction thereof by receiving an electromagnetic attractive force;
a non-magnetic cup member serving as a bearing which houses the moving part in a reciprocatingly slidable manner in the axial direction, and having a bottom portion on one side in the axial direction and being open on the other side thereof;
a stator which houses the cup member in the axial direction and is externally equipped with a coil to generate the electromagnetic attractive force;
a housing which has a port for supplying oil to the hydraulic actuator and a port for discharging drain oil from the hydraulic actuator;
a spool valve which is housed inside the housing in a reciprocatingly slidable manner in the axial direction and reciprocatingly slides integrally with the moving part to open and close each of the ports; and
an oil introduction path which introduces the drain oil inside the housing into a slide bearing portion between the cup member and the moving part,
wherein the oil introduction path is an axial groove provided in an outer periphery of a land portion of the spool valve, and the cup member has a through hole provided in the bottom portion.

2. (canceled)

3. The hydraulic pressure controlling solenoid valve according to claim 1, wherein the oil introduction path is a clearance between an outer periphery of a land portion of the spool valve and an inner periphery of the housing.

4. (canceled)

5. The hydraulic pressure controlling solenoid valve according to claim 1, further comprising:
a positioning portion for spacing the bottom portion of the cup member apart from a bottom portion of the stator.

6. The hydraulic pressure controlling solenoid valve according to claim 3, wherein the positioning portion is provided at a peripheral edge of an opening of the cup member.
